(19) United States
(12) Patent Application Publication
(10) Pub. No.: US 2021/0348644 A1
(43) Pub. Date: Nov. 11, 2021

(54) SLEEVED LUG NUT APPARATUS AND INSTALLATION TOOL

(71) Applicant: Valmont Industries, Inc., Omaha, NE (US)

(72) Inventor: Cory J. Dillon, Bennington, NE (US)

(73) Assignee: Valmont Industries, Inc., Omaha, NE (US)

(21) Appl. No.: 17/306,013

(22) Filed: May 3, 2021

Related U.S. Application Data
(60) Provisional application No. 63/022,651, filed on May 11, 2020.

(51) Int. Cl. F16B 41/00; F16B 23/00

(52) U.S. Cl. CPC F16B 41/005; B60B 3/165; F16B 23/0007

(57) ABSTRACT

The present invention provides an improved lug nut protection system that includes a keyed lug nut and a specialty tool for installation and removal. According to a preferred embodiment, the present invention includes a protective sleeve which slides over the wheel end of a given lug nut, and which is held in place by a retaining ring or the like. According to a further preferred embodiment, the protective sleeve preferably freely rotates and prevents common tools (i.e., pipe wrenches) from removing the lug nut thus preventing theft of the wheel/tire. According to a further preferred embodiment, the lug nut of the present invention is preferably recessed within the protective sleeve and preferably includes a keyed head which requires a specialty tool to remove the lug nut. Preferably, the specialty tool of the present invention fits inside the sleeve and over the top of the custom lug nut design.

### RELATED APPLICATIONS

The present application claims priority to U.S. Provisional Application No. 63/022,651 filed May 11, 2020.

### BACKGROUND AND FIELD OF THE PRESENT INVENTION

### Field of the Present Invention

The present invention relates generally to lug nut design. More specifically, the present invention teaches a sleeved lug nut apparatus and installation tool for preventing the theft of wheels and tires.

### Background of the Invention

There presently exists an on-going issue of wheel/tire theft across a number of industries and vehicle types. This issue is created by the fact that most tires are secured onto vehicle rotors with standard hex-headed lug nuts screwed onto lug nut studs. The standard hex-headed lug nuts are designed to be installed and removed by a standard socket (normally either ¾, 19 mm, 13/16 or 21 mm).

To make lug nuts more secure, special “keyed” shapes have been used in place of the standard hex-headed designs. These are generally referred to as “wheel locks.” Wheel locks are designed to require a matching lug nut key to remove. However, in practice these designs are still subject to theft because a common pipe wrench can typically remove these lug nuts.

Other designs are more successful, such as those shown in U.S. Pat. Nos. D379,428 and 8,016,535, which restrict access to the lug nut head. However, these and other designs (such as U.S. Pat. Nos. 5,918,946, 9,016,096, and 7,392,674) require complicated lug nuts with many parts and/or specialty components. These complicated designs are costly to manufacture. Additionally, the more complicated the design, the more the lug nut tends to project beyond the wheel hub.

In order to make tires/wheels more secure, the present invention provides a new anti-theft lug nut design which is compact, and which prevents common tools from removing lug nuts.

### SUMMARY OF THE INVENTION

To minimize the limitations found in the prior art, the present invention provides an improved lug nut protection system that includes a keyed lug nut and a specialty tool for installation and removal. According to a preferred embodiment, the present invention includes a protective sleeve which slides over the wheel end of a given lug nut, and which is held in place by a retaining ring or the like. According to a further preferred embodiment, the protective sleeve preferably freely rotates and prevents common tools (i.e., pipe wrenches) from removing the lug nut thus preventing theft of the wheel/tire. According to a further preferred embodiment, the lug nut of the present invention is preferably recessed within the protective sleeve and preferably includes a keyed head which requires a specialty tool to remove the lug nut. Preferably, the specialty tool of the present invention fits inside the sleeve and over the top of the custom lug nut design.

### BRIEF DESCRIPTION OF DRAWINGS

FIG. 1 is a side view of an exemplary sleeved lug nut in accordance with a first preferred embodiment of the present invention.

FIG. 2 is a front elevation view of the exemplary sleeved lug nut shown in FIG. 1.

FIG. 3 is a rear elevation view of the exemplary sleeved lug nut shown in FIG. 1.

FIG. 4 is a cut-away side view of the exemplary sleeved lug nut shown in FIG. 1.

FIG. 5 is front perspective view of the exemplary sleeved lug nut shown in FIG. 1 attached to an example rotor.

FIG. 6 is a front perspective view of an exemplary installation/removal tool in accordance with a preferred embodiment of the present invention.

FIG. 7 is front perspective view of the exemplary installation/removal tool shown in FIG. 6 attached to an exemplary sleeved lug nut in accordance with a preferred embodiment.

### DETAILED DESCRIPTION OF THE PREFERRED EMBODIMENTS

Reference is now made in detail to the exemplary embodiments of the invention, examples of which are illustrated in the accompanying drawings. Wherever possible, the same reference numbers will be used throughout the drawings to refer to the same or like parts. The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. As used throughout this application, the word “may” is used in a permissive sense (i.e., meaning “having the potential to’), rather than the mandatory sense (i.e. meaning “must”).

Additionally, any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

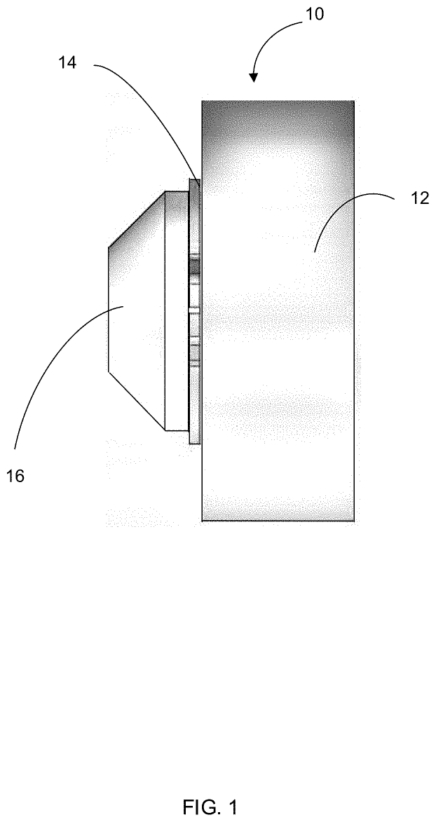

With reference now to FIGS. 1-7, the present invention teaches a sleeved lug nut apparatus and installation tool for preventing the theft of wheels and tires. As should be understood, the examples discussed herein are intended to be illustrative and any of a variety of alternative systems, embodiments and/or configurations may be used with the present invention without limitation.

With reference now to FIG. 1, a side view of an exemplary sleeved lug nut 10 in accordance with a first preferred embodiment of the present invention is provided. As shown, the exemplary sleeved lug nut 10 preferably includes a lug nut 16 with an attached outer sleeve 12. The outer sleeve is preferably attached to the lug nut via a snap ring 14 or the like.

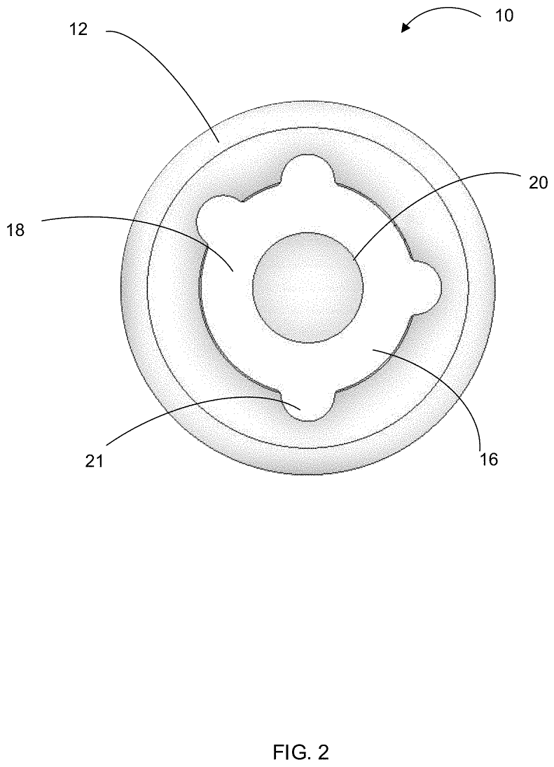

With reference now to FIG. 2, a front elevation view of the exemplary sleeved lug nut 10 is provided. As shown, the lug nut 16 preferably includes a keyed head 18 which includes a keyed outer surface 21 and a threaded inner surface 20. The outer sleeve 12 preferably extends around the circumference of the keyed head 18 at a distance to restrict prying tools or other socket heads from inserting between the outer sleeve 12 and the keyed head 18.

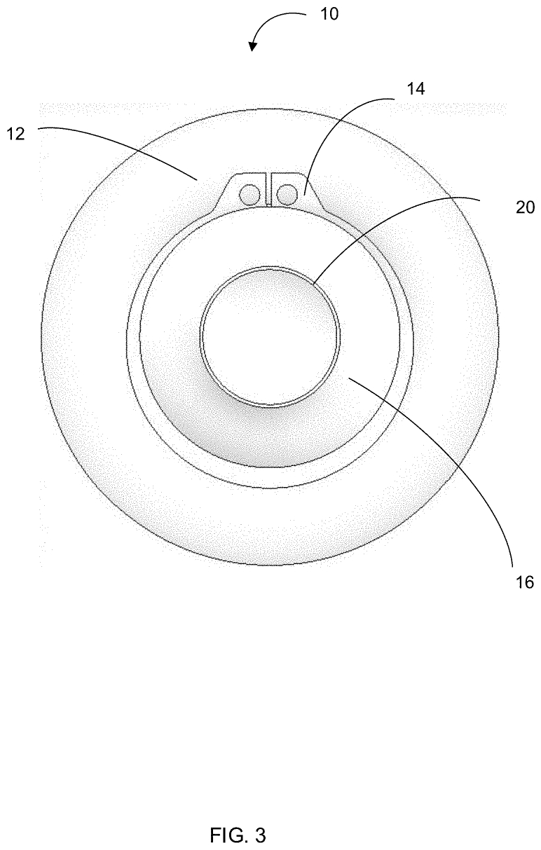

With reference now to FIG. 3, a rear elevation view of the exemplary sleeved lug nut 10 of the present invention is provided. As shown, the snap ring 14 of the present invention preferably extends around the full circumference of the outer sleeve 12 so that the outer sleeve 12 is locked into place around the lug nut body 16. The snap ring 14 is preferably made of stainless steel, plastic or other strong, corrosion resistant material.

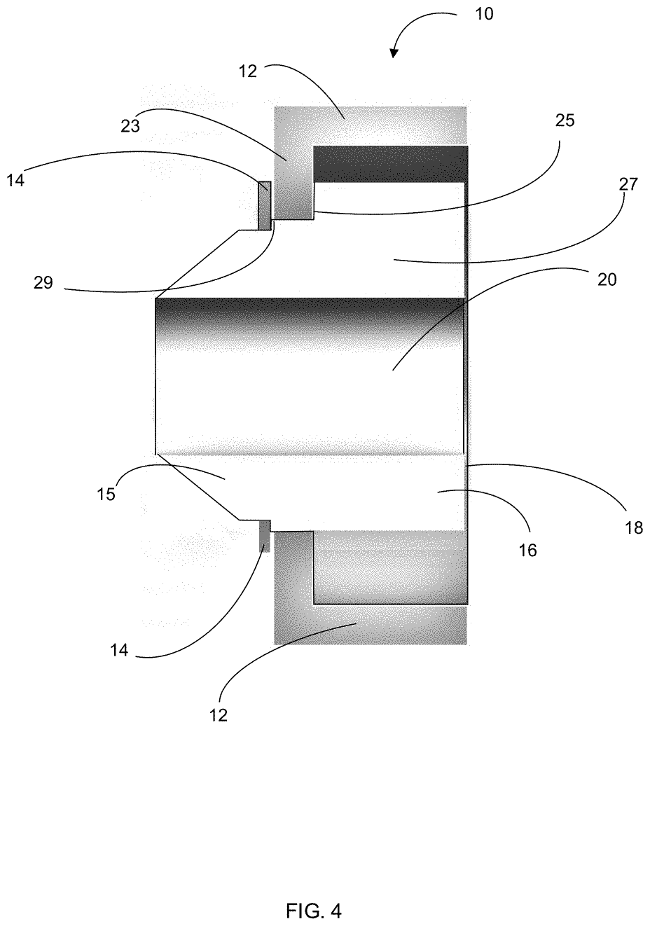

With reference now to FIG. 4, a side cut-away side view of the exemplary sleeved lug nut 10 shown in FIG. 1 is provided. As shown, the outer-sleeve 12 preferably extends around the full circumference of the lug nut 16. Still further, the snap-ring 14 preferably clips onto and extends around the body of the outer sleeve 12 and the lug nut 16 so that it is fictionally held against the snap ring securing flange 29. The outer sleeve 12 preferably further includes a rear surface 23. Preferably, the outer sleeve 12 extends around the lug nut 16 so that the sleeve rear surface 23 is secured against the sleeve securing flange 25 of the lug nut 16.

As further shown in FIG. 4, the lug nut 16 preferably includes a main lug nut body 27 having a threaded inner surface 20 which extends along the main axis of the lug nut 16. The lug nut 16 preferably further includes a conically tapered rear section 15. The outer lug nut sleeve 12 preferably is formed as a substantially hollow cylinder extending around the keyed head 18. Preferably, the outer lug nut sleeve 12 is secured to the main lug nut body 27 with a snap ring 14 so that the outer lug nut sleeve 12 may turn around the main axis of the lug nut 16.

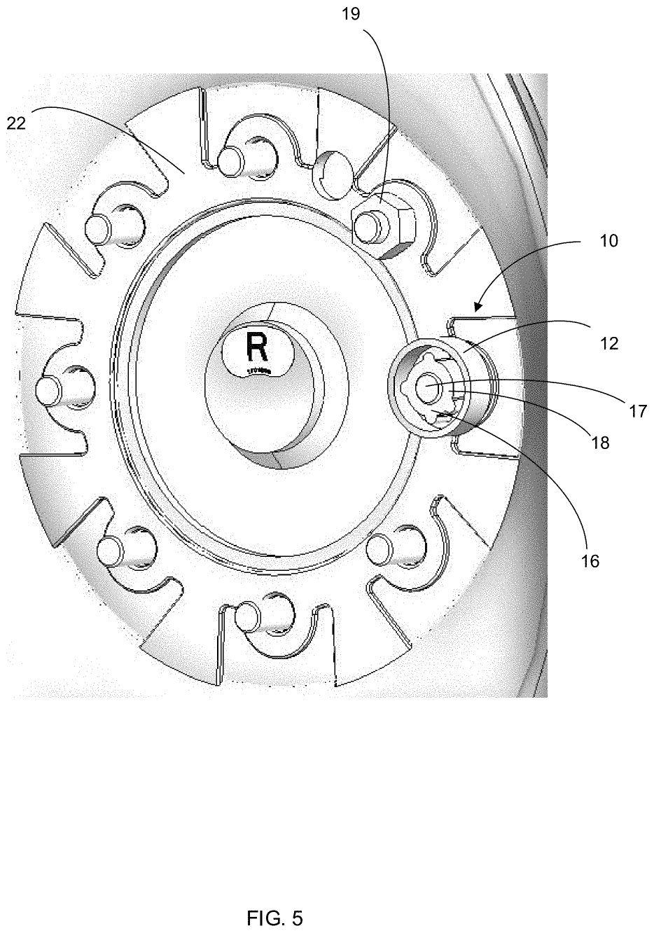

With reference now to FIG. 5, a front perspective view of the exemplary sleeved lug nut 10 attached to an example rotor 22 is provided. A standard lug nut 19 is shown attached to the rotor 22 as well. As shown, the exemplary sleeved lug nut 10 preferably includes a lug nut 16 attached to a lug nut stud 17. The lug nut 16 preferably include a keyed head 18 and a protective outer sleeve 12.

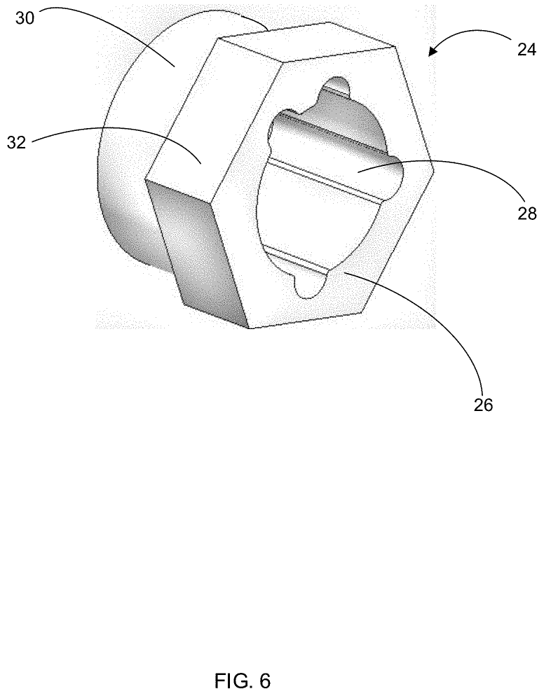

With reference now to FIG. 6, a front perspective view of an exemplary installation/removal tool 24 in accordance with a preferred embodiment of the present invention is provided. As shown, exemplary installation/removal tool 24 preferably includes an insertion sleeve 30 which is preferably sized to fit between the protective sleeve 12 and the keyed head 18 of the lug nut 16 of the present invention. The exemplary installation/removal tool 24 preferably further includes a keyed socket head 26 which may preferably include an exterior surface 32 conforming to a standard socket size and shape. The keyed socket head 26 preferably further includes a keyed inner surface 28 which matches the outer diameter of the keyed head 18. The keyed inner surface 28 may preferably extend through the entire lug nut 10 (as shown) or it may extend only through the insertion sleeve portion 30.

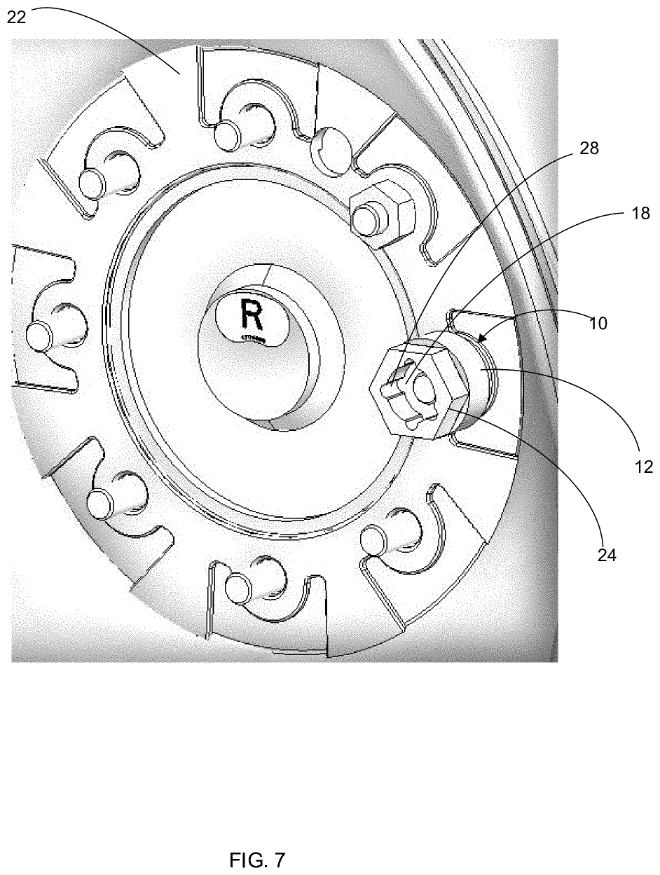

With reference now to FIG. 7, a front perspective view of the exemplary installation/removal tool 24 is shown attached to an exemplary sleeved lug nut 10 of the present invention. As shown, the insertion sleeve 30 of the removal tool 24 is inserted between the outer sleeve 12 and the keyed head 18. In this way, the keyed inner surface 28 of the removal tool 24 preferably slides over and tightly encloses the keyed head 18 so that torque can be applied to the attached lug nut 16.

While the invention has been illustrated and described as embodied in a particular delineator mounting system, it is not intended to be limited to the details shown, since it will be understood that various omissions, modifications, substitutions and changes in the forms and details of the device illustrated and in its operation can be made by those skilled in the art without departing in any way from the spirit of the present invention.

The scope of the present invention should be determined not by the embodiments illustrated, but by the appended claims and their legal equivalents.

What is claimed is:

1. An anti-theft lug nut protection system, wherein the system comprises:
a main lug nut body, wherein the main lug nut body comprises:
a threaded inner surface; wherein the threaded inner surface extends along the main axis of the lug nut;
a conically tapered rear section; and a
a front keyed section; wherein the front keyed section comprises a columnar keyed section; wherein the columnar keyed section comprises a non-hexagonal front surface; wherein the shape of the non-hexagonal front surface extends through at least a portion of the columnar keyed section beyond the non-hexagonal front surface; wherein the non-hexagonal front surface is substantially orthogonal to the main axis of the lug nut; and
an outer lug nut sleeve; wherein the outer lug nut sleeve comprises a substantially hollow cylinder extending around the front keyed section; wherein the outer lug nut sleeve is secured to the main lug nut body with a snap ring; wherein the outer lug nut sleeve is configured to freely turn around the main axis of the lug nut.

2. The system of claim 1, wherein the snap ring extends around the full circumference of the outer lug nut sleeve.

3. The system of claim 2, wherein the outer lug nut sleeve extends around the full circumference of the main lug nut body.

4. The system of claim 3, wherein the system further comprises a removal tool; wherein the removal tool comprises an insertion sleeve.

5. The system of claim 4, wherein the insertion sleeve is configured to fit between the columnar keyed section and the outer lug nut sleeve.

6. The system of claim 5, wherein the removal tool comprises a keyed socket head.

7. The system of claim 6, wherein the removal tool comprises an exterior surface conforming to a standard socket size and shape.

8. The system of claim 7, wherein the keyed socket head comprises a keyed inner surface.

9. The system of claim 8, wherein the keyed inner surface is shaped to match an outer diameter of the front keyed section.

10. The system of claim 9, wherein the keyed inner surface is configured to slide over and enclose the front keyed section to allow torque to be applied to an attached main lug nut body.
